(19) United States
(12) Patent Application Publication
(10) Pub. No.: US 2010/0226732 A1
(43) Pub. Date: Sep. 9, 2010

(54) SELF-TAPPING SCREW

(75) Inventors: Michael BAUMGARTNER, Montlingen (CH); Albert Loichinger, Sax (CH)

Correspondence Address: CROWELL & MORING LLP;INTELLECTUAL PROPERTY GROUP, P.O. BOX 14300, WASHINGTON, DC, 20044-4300, US

(73) Assignee: Hilti Aktiengesellschaft, Schaan (LI)

(21) Appl. No.: 12/715,975

(22) Filed: Mar. 2, 2010

(30) Foreign Application Priority Data
Mar. 3, 2009 (DE) 10 2009 001 298.2

(51) Int. Cl. F16B 25/10

(52) U.S. Cl. 411/387.1

(57) ABSTRACT

A self-tapping screw is disclosed. The screw having a shaft bearing at least partially a thread, which shaft defines a longitudinal axis and on whose first end a drill point with a maximum width and on whose opposing second end a head are arranged, as well as having at least one first cutting edge and having at least one second cutting edge. A recess through which the longitudinal axis passes is arranged between the two cutting edges, with the minimum axial depth of the recess corresponding to at least 0.08 times the maximum width of the drill point.

This application claims the priority of German Patent Document No. 10 2009 001 298.2, filed Mar. 3, 2009, the disclosure of which is expressly incorporated by reference herein.

### BACKGROUND AND SUMMARY OF THE INVENTION

The present invention relates to a self-tapping screw. These types of self-tapping screws are used in particular for screwing sheet metal to supports.

A self-tapping screw with a head and an adjoining shaft are known from German Patent Document No. DE 25 51 510 A1, which has a drill point with a first cutting edge and with a second cutting edge on its end facing away from the head. In the region of the point of the self-tapping screw, an edge runs between the two cutting edges, which crosses the longitudinal axis of the self-tapping screw.

The disadvantage of this kind of self-tapping screw is that the cutting speed in the center of the drill hole is virtually zero, because there is only very ineffective chip removal on the edge.

A tapping screw is known from European Document No. EP 0 468 089 B1, which has a drill point on its end facing away from the head, which features two points in the end region. Curved cutting edges go off from these points respectively towards the radial outside. Furthermore a tool cutting edge also extends between the two points.

The chip removal in the axial region of the drill point is somewhat more effective in the case of this tapping screw than is the case with the previously described one. The disadvantages of this tapping screw, however, are the two sensitive points, which are subject to great stress. Furthermore, this geometry can only be realized very laboriously in terms of the metal forming and is therefore expensive to manufacture.

The object of the present invention is avoiding the disadvantages cited above and making available a self-tapping screw, with which effective material removal is possible also in the region of the axial point.

According to this, a recess through which the longitudinal axis passes is arranged between the two cutting edges, with the minimum axial depth of the recess corresponding to at least 0.08 times the maximum width of the drill point. Because of the point geometry in accordance with the invention, a drilling core remains in the axial region during drilling, which breaks off of the drilled base piece by piece and thus is transported out of the drill hole as a larger piece (as compared to the otherwise customary chips). The removal rate of the drill point of the self-tapping screw and therefore its drilling speed are distinctly improved as a result.

The minimum axial depth of the recess advantageously corresponds to 0.1 to 4 times the maximum width of the drill point, thereby achieving an optimum configuration of the core length until breakage of the core.

Furthermore, it is advantageous if a base of the recess lying in the axial direction is embodied as a ramp running diagonally towards one side. Because of the ramp or slant of the ramp at the base of the recess, it is easier for the core to break off thereby improving drilling progress.

It is also advantageous if the recess is slot-shaped and is embodied to be open towards at least one chip channel running laterally on the drill point. Because of the slot-shaped embodiment, it is easier to manufacture the recess and because of the opening towards at least one chip channel, easy removal of the broken-off core is possible.

A width of the recess in a direction parallel to the radial progression of the cutting edges preferably corresponds to 0.1 to 0.6 times the maximum width of the drill point, thereby achieving an optimum design between the radial length of the cutting edges (and therefore their breaking strength) and the removal capability for the drilling core accommodated in the recess.

The invention is depicted in the drawings in an exemplary embodiment.

### BRIEF DESCRIPTION OF THE DRAWINGS

FIG. 1 illustrates a self-tapping screw according to the present invention.

FIG. 2 is a detail of the self-tapping screw according to marking II from FIG. 1.

FIG. 3 is the detail of the self-tapping screw from FIG. 2 in a view in the direction of arrow Ill from FIG. 2.

FIG. 4 is the detail of the self-tapping screw from FIG. 2 in a workpiece.

### DETAILED DESCRIPTION OF THE DRAWINGS

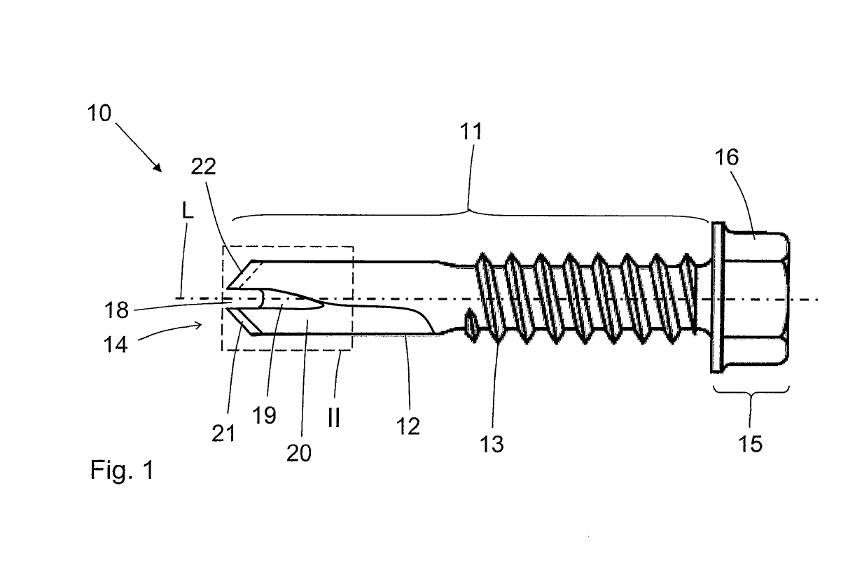

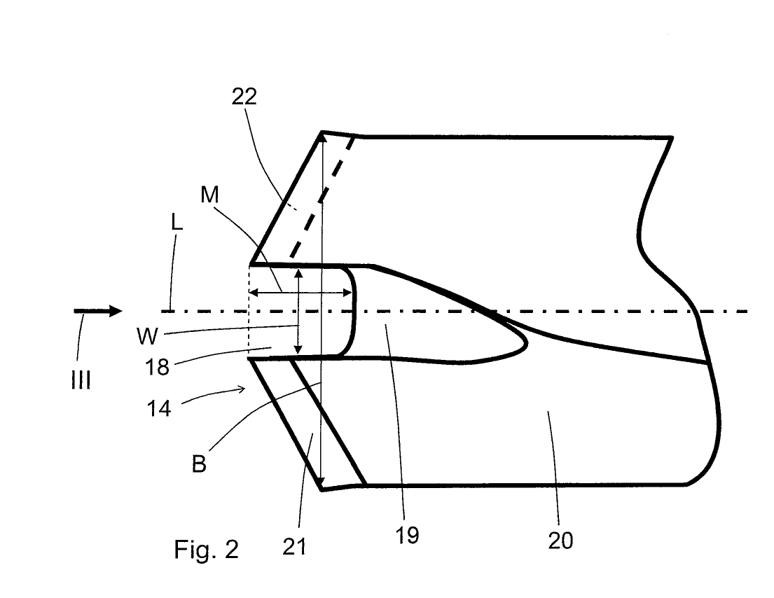

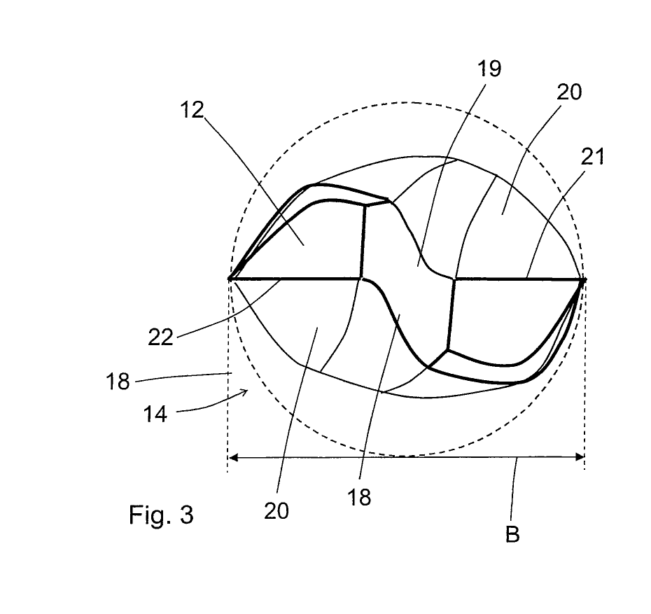

The self-tapping screw 10 depicted in FIGS. 1 to 4 has a shaft 11 bearing a thread 13, on whose one end region a drill point 12 and on whose opposing other end a head 15 are arranged. In this case, a longitudinal axis L of the self-tapping screw 10 defines an axial direction of the self-tapping screw 10. The head 15 features a rotary pick-up structure 16 embodied as a polygon for a fastening tool, such as a screwdriver bit or a screw-wrench.

The drill point 12 has a first cutting edge 21 and a second cutting edge 22 on its free end 14 facing away from the head 15, which a respective chip channel 20 adjoins. Moreover, the drill point 12 has a maximum width B in the region of the cutting edges 21, 22, which is somewhat larger (e.g., up to 0.2 mm larger) than the average diameter or the average width of the drill point 12. Alternatively, the width B in the region of the cutting edges 21, 22 may also be the same size as the average diameter or the average width of the drill point 12.

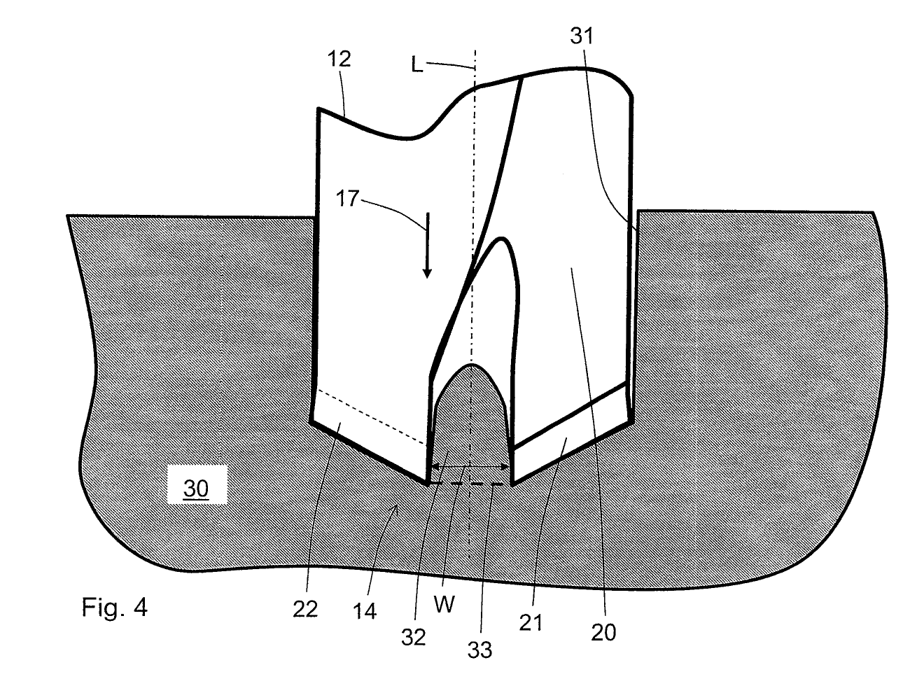

In the region of the longitudinal axis L, a recess 18 starting from the free end 14 is arranged on the drill point 12. This recess 18 is embodied to be slot-shaped and is open towards both chip channels 20. The recess 18 extends along the longitudinal axis L and separates the first cutting edge 21 and the second cutting edge 22 from each other. The longitudinal axis L passes through the recess 18 preferably in the center, thereby producing an advantageous rotational symmetry of the recess 18 with respect to the longitudinal axis L. The base of the recess 18 lying in the axial direction is embodied as a ramp 19 running diagonally towards one side or towards a chip channel 20. The minimum axial depth M of the recess, which is measured between the axial opening of the recess 18 and the end of the ramp 19 lying in the screw-in direction 17 (see FIG. 4), corresponds to at least 0.08 times, preferably 0.1 to 4 times the maximum width B of the drill point 12. A width W of the recess 18 in a direction parallel to the radial progression of the cutting edges 21, 22 corresponds to 0.1 to 0.6 times the maximum width B of the drill point 12.

In FIG. 4, the drill point 12 of the self-tapping screw 10 has penetrated during the start of a drilling process into a workpiece 30, such as, for example, a steel girder, forming a drill hole 31. As the FIG. 4 shows, the columnar core 32 remains in the center in the drill hole 31, which extends into the recess 18. When, with further drilling progress, the columnar core 32 extends up to the diagonal ramp 19, it is pushed out of the way laterally by this ramp 19 and in the process is separated from the workpiece 30 (e.g., broken off) on a breaking edge 33.

To reduce friction, the self-tapping screw can also be provided at least in the region of the shaft 11 with a friction-reducing coating, such as, for example, a wax or oil.

It is understood that, instead of the two cutting edges 21, 22 depicted here, even more, e.g., three or four, cutting edges could be provided.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A self-tapping screw, comprising:
a shaft bearing at least partially a thread, wherein the shaft defines a longitudinal axis, wherein a first end of the shaft includes a drill point with a maximum width, wherein an opposing second end of the shaft includes a head, and wherein the shaft has a first cutting edge and a second cutting edge;
and further wherein a recess defined by the shaft, through which the longitudinal axis passes, is arranged between the first and second cutting edges and wherein a minimum axial depth of the recess corresponds to at least 0.08 times the maximum width of the drill point.

2. The self-tapping screw according to claim 1, wherein the minimum axial depth corresponds to 0.1 to 4 times the maximum width of the drill point.

3. The self-tapping screw according to claim 1, wherein a base of the recess lying in an axial direction is embodied as a ramp running diagonally towards a side of the drill point.

4. The self-tapping screw according to claim 1, wherein the recess is slot-shaped and is embodied to be open towards a chip channel running laterally on the drill point.

5. The self-tapping screw according to claim 1, wherein a width of the recess in a direction parallel to a radial progression of the first and second cutting edges corresponds to 0.1 to 0.6 times the maximum width of the drill point.
